(19) United States
(12) Patent Application Publication
(10) Pub. No.: US 2010/0188051 A1
(43) Pub. Date: Jul. 29, 2010

(54) Secondary battery charging circuit

(75) Inventors: Kazuo Yamazaki, Kanagawa (JP); Hidenori Tanaka, Kanagawa (JP); Yukihiro Terada, Kanagawa (JP); Tamiji Nagai, Tokyo (JP); Toshio Nagai, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: MITSUMI ELECTRIC CO; LTD., TOKYO (JP)

(21) Appl. No.: 12/308,283

(22) PCT Filed: Jun. 13, 2007
(86) PCT No.: PCT/JP2007/061880

§ 371 Date: Dec. 11, 2008

(30) Foreign Application Priority Data
Jun. 14, 2006 (JP) 2006-164458

(51) Int. Cl. H02J 7/00

(52) U.S. Cl. 320/148; 320/164

(57) ABSTRACT

The present invention provides a highly safe charging circuit with which overcharge of a secondary battery will never occur even when a failure occurs in a transistor or the like that controls the charging voltage or charging current or when a protection circuit does not operate normally. In a secondary battery charging circuit 4 that charges a secondary battery E2 with an input power source voltage, the power source voltage is set to a voltage (e.g. 4.0 V) that is lower than the full-charge voltage (e.g. 4.2 V) of the secondary battery. When the voltage of the secondary battery E2 is lower than the power source voltage, a constant current circuit operates to perform constant current charging without voltage step-up, and when the voltage of the secondary battery E2 is higher than the power source voltage and lower than the full-charge voltage, a voltage step-up circuit operates to perform constant current charging with voltage step-up.

### TECHNICAL FIELD

The present invention relates to a secondary battery charging circuit that charges a secondary battery such as, for example, a lithium ion battery.

### BACKGROUND ART

If a secondary battery such as, for example, a lithium ion battery continues to be charged with a voltage higher than a prescribed full-charge voltage, there arise problems such as an abnormal rise in the internal pressure of the battery and generation of heat. Such problems also occur when the charging current becomes excessively large. In view of this, lithium ion batteries or the like are generally provided with a protection circuit built in a battery pack so as to prevent the charging voltage and charging current from becoming excessively high.

The following technologies, which are relevant to the present invention, have been disclosed. Japanese Patent Application Laid Open No. 07-143683 discloses a charging circuit that controls the charging voltage using a voltage step-up circuit so that the charging current is kept constant, in order to reduce power loss during charging. Japanese Utility Model Application Laid-Open No. 57-183029 discloses a battery charging apparatus having a circuit that raises the charging voltage in accordance with rises in the voltage of the battery.

### DISCLOSURE OF THE INVENTION

### The Problems to be Solved by the Invention

As described above, overcharge of a secondary battery causes serious problems. Therefore, it is necessary to take multiple countermeasures to prevent such problems from occurring. In particular, the inventors of the present invention made a study to determine whether it is possible to completely eliminate the disadvantage that when a failure occurs in a bipolar transistor or a field effect transistor that restricts the input voltage or input current from a power source and changes it into a prescribed charging voltage or charging current, or when a protection circuit does not operate normally, a high power source voltage is directly input to a secondary battery and the battery continues to be charged with a voltage higher than a prescribed full-charge voltage.

Based on the result of the study, the inventors concluded that above described situation can almost be prevented from occurring by setting the power source voltage lower than the full-charge voltage. In this case, however, it is necessary to make a new inventive design as to the charging method and the way of providing the protection circuit that is different from the design for the case in which the power source voltage is high.

An object of the present invention is to provide a highly safe charging circuit with which overcharge of a secondary battery will never occur even when a failure occurs in a transistor or the like that controls the charging voltage or charging current or when a protection circuit does not operate normally.

### Means for Solving the Problem

According to the present invention, in order to achieve the above-described object, in a secondary battery charging circuit that charges a secondary battery by an input power source voltage, the power source voltage is set to be lower than a full-charge voltage of the secondary battery.

By this countermeasure, even if a failure occurs in a control device of the charging circuit, and the power source voltage is directly input to the secondary battery, a voltage higher than the full-charge voltage will not be applied, and overcharge of the secondary battery can be prevented from occurring. Furthermore, even if the power source voltage is directly input to the secondary battery at a time when the percentage of charge of the secondary battery is low, inflowing of excessive charging current can be made smaller as compared to cases in which a high voltage is input.

It is desirable that the secondary battery charging circuit be provided with a power source voltage detection circuit (3: FIG. 5) that detects the power source voltage, and the power source voltage detection circuit be configured to activate charging operation when it detects that the power source voltage is lower than the full-charge voltage. It is also preferred that the secondary battery charging circuit be equipped with a first switch device (FET0: FIG. 5) provided in a current path that connects the power source voltage and the secondary battery to open and close the current path, and the power source voltage detection circuit be configured to turn the first switch device off when it detects that the power source voltage is higher than the full-charge voltage.

By this configuration, even if a high power source voltage is input inadvertently by, for example, connection with an AC adaptor having a difference output voltage, or if the power source voltage becomes temporarily high due to malfunction of the power source apparatus, overcharge is prevented from being caused thereby.

Specifically, the secondary battery charging circuit may be provided with a current circuit (20) that controls current supplied from the power source voltage to the secondary battery and a voltage step-up circuit (30) that steps-up the power source voltage, and the current circuit may be configured to operate to perform constant current charging without voltage step-up when the voltage of the secondary battery is lower than the power source voltage and to perform constant current charging with voltage step-up when the voltage of the secondary battery is higher than the power source voltage and lower than the full-charge voltage.

By this configuration, the secondary battery can be fully charged using the power source voltage that is lower than the full-charge voltage. In the voltage step-up circuit, a failure of the switching device that achieves the voltage step-up operation leads to a decrease in the output voltage, and in addition fault factors that may lead to increases in the output voltage can be made very small. Therefore, the degree of safety is much improved in the case where the voltage step-up circuit is used as compared to the case where a high power source voltage is input.

More specifically, the secondary battery charging circuit may be provided with a voltage difference detection circuit (60: FIG. 9) that detects a voltage difference between the power source voltage and the voltage of the secondary battery, and when the voltage difference detection circuit detects that the voltage difference becomes equal to or lower than a reference value during a period of the constant current charging without voltage step-up, the voltage step-up circuit may be activated based thereon to make the shift to the constant current charging with voltage step-up.

Alternatively, the secondary battery charging circuit may be provided with a current decrease detection circuit (52: FIG. 10) that detects a decrease in the charging current, and when the current detection circuit detects that the charging current has decreased by a specific amount during a period of the constant current charging without voltage step-up, the voltage step-up circuit may be activated based thereon to make the shift to the constant current charging with voltage step-up.

By the above configurations, the voltage step-up circuit can be activated at an appropriate timing.

It is also preferred that the secondary battery charging circuit be provided with a battery voltage detection circuit (40: FIG. 12) that detects the voltage of the secondary battery, and the current circuit be configured to change the magnitude of the charging current based on the voltage value of the secondary battery.

Specifically, when the voltage of the secondary battery is higher than a minimum operation voltage of a system that operates with voltage supply from the secondary battery, the current circuit may adjust the charging current to a first current value, and when the voltage of the secondary battery is lower than the minimum operation voltage, the current circuit may adjust the charging current to a current value that is smaller than the first current value.

Alternatively, the secondary battery charging circuit may be provided with a control terminal (t1: FIG. 15) to which a signal indicative of an operation mode of a system that operates with voltage supply from the secondary battery is input from the system, and the current circuit may change the magnitude of the charging current based on the signal on the control terminal.

In the case of a system such as, for example, a cellular phone in which a secondary battery can be charged as it is set in the apparatus, the power source voltage for charging may sometimes be used also as a power source for driving the system during charging. In such cases, if a large part of the power supplied from the power source is used only in charging, driving of the system by the power source voltage may be in trouble in some cases. By changing the charging current smaller when the voltage of the secondary battery is low or in accordance with the activation state of the system as described above, the power supplied from the power source can be appropriately shared by both charging of the secondary battery and driving of the system.

It is also preferred that the secondary battery charging circuit be provided with a fuse (82: FIGS. 16 and 17) provided in a current path that connects the power source voltage and the secondary battery, a voltage and current detection circuit (80) that detects the power source voltage and an input current and a second switch device (FET1) directly connected with the fuse, and the second switch device be configured to be turned on to blow the fuse when the power source voltage or input current exceeds a limit value.

It is more preferred that the secondary battery charging circuit be provided with a rectifying device (D1: FIG. 16) or a third switch device (FET2: FIG. 17) that can block current from the secondary battery so as to prevent current from flowing from the secondary battery to the second switch device when the second switch device is turned on.

By such protection means, in case that an excessively high voltage or an excessively large current is input due to a failure, a high degree of safety can be ensured by blowing the fuse to isolate the secondary battery from the voltage and current. In addition, when the fuse is blown, over-discharge from the secondary battery can be prevented from occurring.

Although in this section signs indicating the correspondences with the embodiments have been presented in parenthesis, the present invention is not limited by them.

### EFFECTS OF THE INVENTION

As described in the forgoing, according to the present invention, even in cases where a failure occurs in a control device in a charging circuit, or a protection circuit does not operate normally, a high degree of safety can be achieved, and overcharge of a secondary battery will never occur.

### BRIEF DESCRIPTION OF THE DRAWINGS

FIG. 1 is a block diagram showing the basic configuration of a charging system according to a first embodiment of the present invention.

FIG. 2 is a detailed block diagram showing charging circuit portion of the charging system shown in FIG. 1.

FIG. 3 is a diagram showing an exemplary circuit configuration of the charging system according to the first embodiment.

FIG. 4 is a diagram showing an exemplary circuit configuration of the charging system according to the first embodiment.

FIG. 5 is a graphical illustration of charging characteristics explaining operation of the charging system according to the first embodiment.

FIG. 6 is a block diagram showing the basic configuration of a charging system according to a second embodiment.

FIG. 7 is a diagram showing an exemplary circuit configuration of the charging system according to the second embodiment.

FIG. 8 is a flow chart showing an exemplary operation procedure of the charging system according to the second embodiment.

FIG. 9 is a circuit diagram of a charging system according to a third embodiment.

FIG. 10 is a circuit diagram of a charging system according to a fourth embodiment.

FIG. 11 is a charging characteristic diagram illustrating operation of the charging system according to the fourth embodiment.

FIG. 12 is a circuit diagram of a charging system according to a fifth embodiment.

FIG. 13 is a charging characteristic diagram illustrating operation of the charging system according to the fifth embodiment.

FIG. 14 is a charging characteristic diagram illustrating a modification of the operation of the charging system according to the fifth embodiment.

FIG. 15 is a circuit diagram of a charging system according to a sixth embodiment.

FIG. 16 is a circuit diagram of a charging system according to a seventh embodiment.

FIG. 17 is a circuit diagram showing a modification of a configuration for blowing a fuse.

FIG. 18 is a charging characteristic diagram illustrating operation of the charging system according to a eighth embodiment.

FIG. 19 is a circuit diagram of a first modification that enables power supply from a secondary battery to a system circuit through a charging circuit.

FIG. 20 is a circuit diagram of a second modification that enables power supply from a secondary battery to a system circuit through a charging circuit.

### EXPLANATION OF REFERENCE NUMERAL

2: power source apparatus
3: power source voltage detection circuit
4: charging circuit
E2: secondary battery
20: constant current circuit
Q1: transistor for current control
21: constant current control circuit
25: detection control and constant current control circuit
30: voltage regulator (voltage step-up circuit)
L1: reactor
D1: rectifying device
FET2: transistor for synchronous rectification
FET1: transistor
31: SW control circuit
40: voltage detection circuit
50: switch control circuit
60: voltage difference detection circuit
70: current changing control circuit
t1: input terminal (control terminal)
80: abnormality detection circuit
82: fuse
90: discharge control circuit
100: system circuit

### THE BEST MODE FOR CARRYING OUT THE INVENTION

In the following, embodiments of the present invention will be described with reference to the drawings.

### First Embodiment

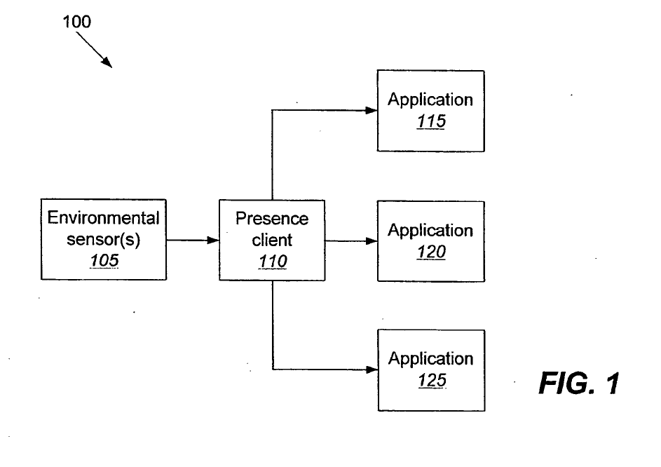

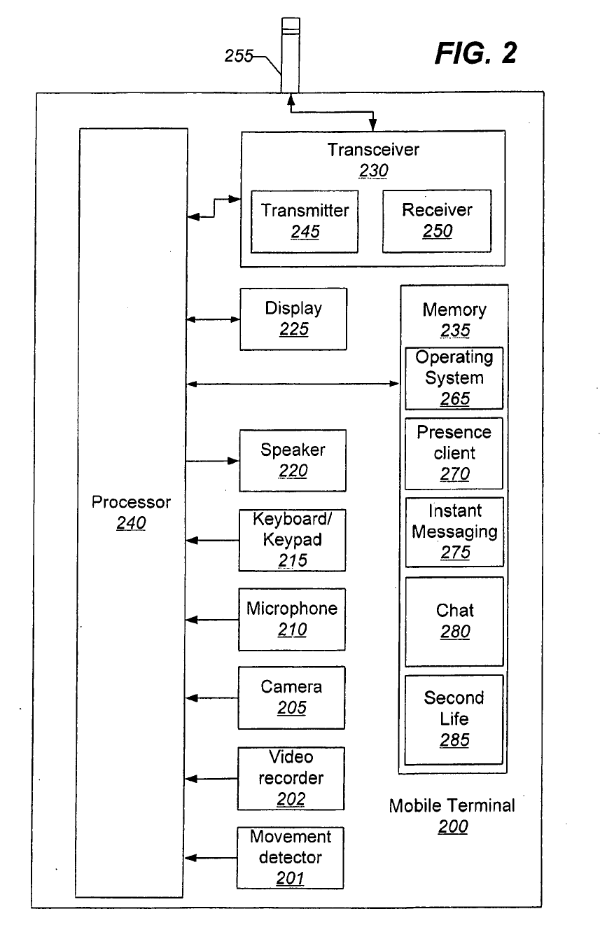

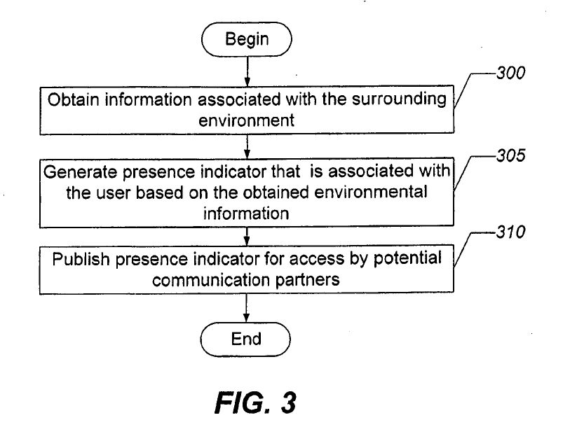

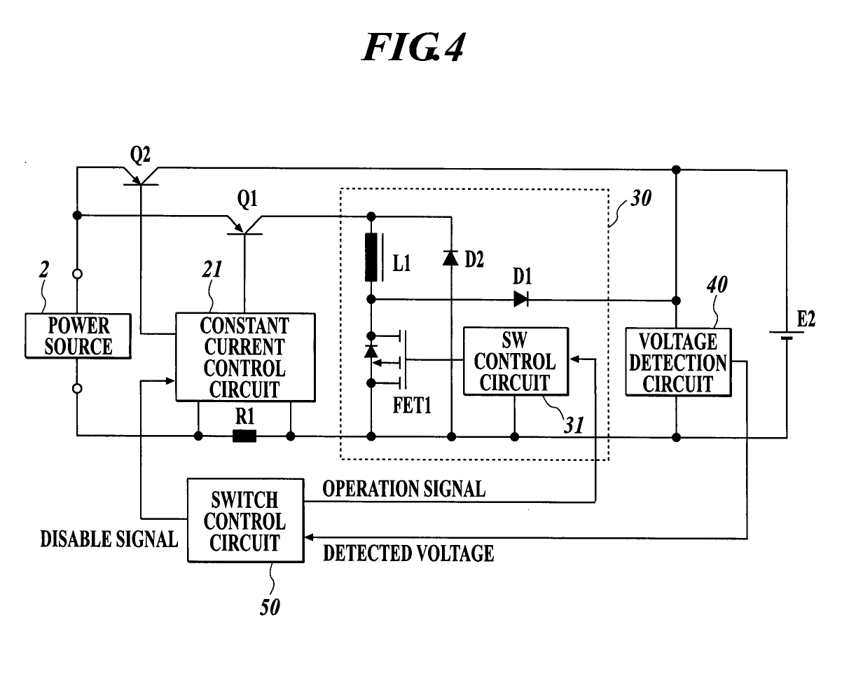

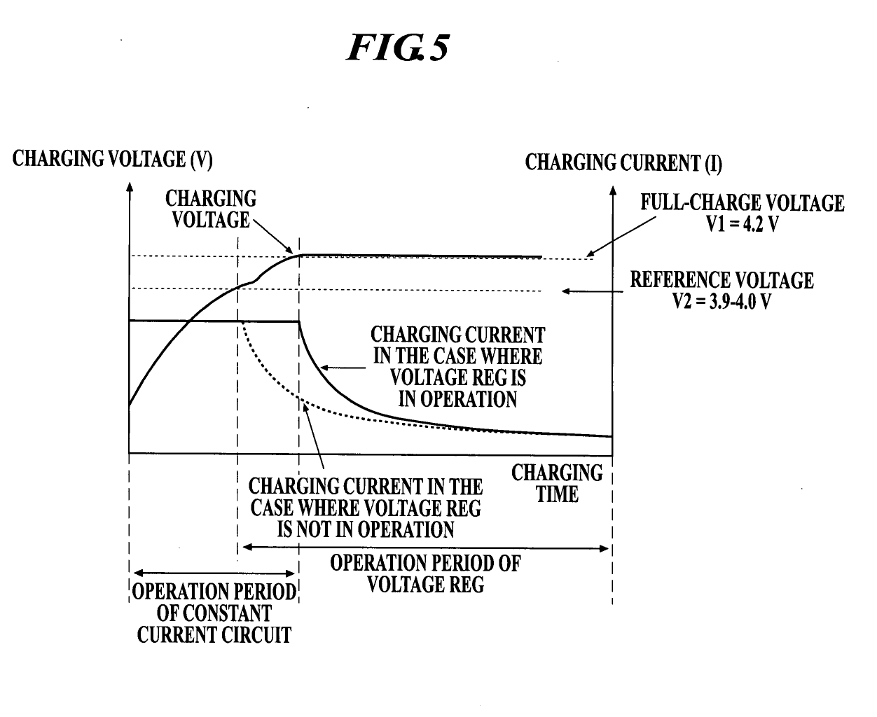

FIG. 1 is a block diagram showing the basic configuration of a charging system according to a first embodiment of the present invention, FIG. 2 is a block diagram showing the configuration of a charging circuit, and FIGS. 3 and 4 are diagrams showing exemplary circuit configurations of the charging circuit. FIG. 5 is a graphical illustration of charging characteristics explaining the operations of this charging system.

The charging system according to this embodiment charges a secondary battery E2 such as, for example, a lithium ion battery by a power source voltage supplied from a power source apparatus 2 such as, for example, an AC adaptor. The charging system is provided with a charging circuit 4 to which power source voltage is input and that outputs charging voltage to the secondary battery E2.

A general method of charging a lithium ion battery or the like is as follows. When the percentage of charge of a lithium ion battery is low, the voltage between its terminals is low. Charging is started from this state by applying a voltage a little higher than the battery voltage. As the percentage of charge increases, the voltage between the terminals rises to eventually reach a specific full-charge voltage (e.g. 4.1 V or 4.2 V) at which structural deterioration of the battery is prevented. After the full-charge voltage is reached, constant-voltage charging is performed by application of the full-charge voltage, wherein the charging current decreases with an increase in the percentage of charge. When the charging current becomes sufficiently small, charging is terminated.

In the charging system according to this embodiment, the power source voltage input from the power source apparatus 2 is set to be a voltage lower than the full-charge voltage of the secondary battery E2. Although no particular limitations are placed on the power source voltage, it may be set to, for example, 3.5 to 4.0 V.

The charging circuit 4 includes, as shown in FIG. 2, a constant current circuit(s) 20, 20B that controls the current output to the secondary battery E2, a voltage regulator 30 that can perform a voltage step-up operation by switching control, a voltage detection circuit 40 for detecting the charging voltage applied to the secondary battery E2, and a switch control circuit 50 that switches the operation of the constant current circuit(s) 20, 20B and the voltage regulator 30 based on the detected voltage value.

In connection with the above, the portion drawn by the alternate long and short dash lines in FIG. 2 indicates that both a circuit configuration including this portion and a circuit configuration not including this portion are possible. FIG. 3 is a diagram showing the circuit configuration that does not have the portion drawn by the alternate long and short dash lines, and FIG. 4 is a diagram showing the circuit configuration that has the portion drawn by the alternate long and short dash lines.

The circuit configuration that does not have the portion drawn by the alternate long and short dash lines will first be described.

As shown in FIG. 3, the constant current circuit 20 is made up of a transistor (bipolar transistor) Q1 that controls the output current by changing the on-resistance in a non-saturated range of operation or by switching operation and a constant current control circuit 21 that controls the transistor Q1 by detecting an input current using a resistance R1 or the like.

The constant current circuit 20 can operate in an inactive state in which the transistor Q1 is turned on based on a signal from the switch control circuit 50 so that the power source voltage is directly output to the subsequent circuit and in a protection operation state in which the transistor Q1 is turned off so that input of the power source voltage is shut off, as well as in a constant current operation state for keeping the output current constant.

As shown in FIG. 3, the voltage regulator 30 is composed of a reactor L1 that stores energy when supplied with current, a transistor (field effect transistor) FET1 that supplies current to the reactor L1 by switching operation, an rectifying device D1 that blocks reverse current flow from the output side when the transistor FET1 is on, and a SW control circuit 31 that performs on/off control for the transistor FET1.

When not in operation, the voltage regulator 30 smoothes the current output from the constant current circuit 20 by the reactor L1 and supplies the current to the secondary battery E2. When in operation, the voltage regulator 30 performs a voltage step-up operation in Which the transistor FET1 is caused to operate at a specific frequency and a specific duty ratio, and when the output voltage reaches the full-charge voltage, the voltage regulator 30 operates in such a way as to maintain this voltage.

Next, operations of the charging system having the above-described configuration will be described.

When the charging system normally operates, a power source voltage (e.g. 4.0 V) that is lower than the full-charge voltage (e.g. 4.2 V) is supplied from the power source apparatus 2. As shown in FIG. 5, the charging circuit 4 has three operation states, namely a state of constant current charging without voltage step-up in which only the constant current circuit 20 is in operation, a state of constant current charging with voltage step-up in which the constant current circuit 20 and the voltage regulator 30 are in operation, and a state of constant voltage charging in which only the voltage regulator 30 is in operation. Switching among these operation states is performed by outputting a disable signal and an operation signal from the switch control circuit 50 to the constant current control circuit 21 and the SW control circuit 31 based on detection of the battery voltage.

When the voltage of the battery under charge is lower than the full-charge voltage, the switch control circuit 50 causes the constant current circuit 20 to operate. When the battery voltage reaches the full-charge voltage, the switch control circuit 50 outputs a disable signal to the constant current control circuit 21 to turn the transistor Q1 on. The switch control circuit 50 does not causes the voltage regulator 30 to operate until the voltage of the battery under charge comes close to the power source voltage, and when the battery voltage reaches close to the power source voltage, it outputs an operation signal to the SW control circuit 31 to start the voltage step-up operation.

Here, operation timing of the voltage regulator 30 can be generated by comparing the battery voltage with a reference voltage, which is a voltage substantially equal to or a little lower than the power source voltage that has been set in advance. In a case where the power source voltage is 4.0 V, the reference voltage may be set, for example, within the range of 3.9 V to 4.0 V.

During the operation period of the constant current circuit 20, constant current (e.g. 1 C, where C is a current amount with which the battery can be charged to its capacity in 1 hour) is output from the constant current circuit 20 and input to the secondary battery through the voltage regulator 30. Thus, constant current charging at 1 C is performed. During a period in which the charging voltage is higher than the power source voltage, the voltage regulator 30 performs voltage step-up operation to supply current to the secondary battery E1, whereby constant current charging at 1 C is maintained.

In the circuit shown in FIG. 3, since when the voltage regulator 30 is in operation, switching current of the voltage regulator 30 also flows through the current detection resistance R1 of the constant current circuit 20 in addition to charging current, the constant current control circuit 21 is configured to perform conversion process between the output current and the detected current so as to eliminate this additional amount of current to thereby output constant current of 1 C to the secondary battery. In this connection, the current detection resistance may be provided downstream of the voltage regulator 30 to perform current detection in a section downstream of the voltage regulator 30 rather than a section upstream of the voltage regulator 30 as is the case with FIG. 3, thereby eliminating the above described conversion process.

During the period in which the constant current circuit 20 is disabled and only the voltage regulator 30 is in operation, the transistor Q1 in the constant current circuit is in the ON state, and the voltage regulator 30 performs constant voltage control operation to maintain the voltage output at the full-charge voltage. This voltage is applied to the secondary battery E2, whereby the constant voltage charging is performed.

By this charging process, the secondary battery E2 is fully charged with the power source voltage that is lower than the full-charge voltage.

If, for example, a voltage higher than the full-charge voltage is detected by the voltage detection circuit 40 during the above described charging process, an abnormal signal may be output from the switch control circuit 50 to the constant current control circuit 21 for a certain time period, and the transistor Q1 may be turned off by the abnormal signal to shut off the supply of power source voltage from the power source apparatus 2 for a certain period of time.

Next, a charging circuit including the portion drawn by the alternate long and short dash lines in FIG. 2 will be described. FIG. 4 shows this circuit configuration.

This charging circuit is provided, in addition to the components similar to those in FIG. 3, with a second constant current circuit 20B that outputs current directly to the secondary battery E2 without intervention of the voltage regulator 30 therebetween. Specifically, as shown in FIG. 4, the second constant current circuit 20B has a transistor Q2 that is connected between a power source voltage terminal and a terminal of the secondary battery E2 without a reactor or the like. Although a circuit that controls the operation of the transistor Q2 is illustrated as one block jointly with the constant current control circuit 21 with the circuit for controlling the transistor Q1 being incorporated, the control circuits may be provided separately.

In this circuit configuration, during the period in which the voltage of the battery is lower than the voltage of the power source, the first constant current circuit 20 is disabled and only the second constant current circuit 20B is enabled to perform constant current charging of the secondary battery E2. Such control can eliminate loss in the reactor L1 and the rectifying device D1 during the constant current charging without voltage step-up.

When the voltage of the battery becomes higher than the voltage of the power source, the second constant current circuit 20B is disabled, the transistor Q2 is turned off, and the first constant current circuit 20 and the voltage regulator 30 are enabled to perform the constant current charging with voltage step-up. The operation after that is the same as that in the charging circuit shown in FIG. 3.

In the circuit shown in FIG. 4, the voltage regulator 30 is provided with a rectifying device D2 having an anode connected to the ground terminal, which enables supply of current to the reactor L1 even when the input of the voltage regulator 30 is blocked. Thus, even when the transistor Q1 in the constant current circuit is suddenly turned off while the voltage regulator 30 is in operation, current is supplied to the reactor L1 through the rectifying device D2, whereby the device is prevented from being damaged. In addition, the degree of freedom of control operation can be increased in, for example, that the switching control of the constant current circuit and the switching control of the voltage regulator may be left unsynchronized.

As described above, according to the charging system of this embodiment, since the power source voltage is set to be lower than the full-charge voltage, a voltage higher than the full-charge voltage will not be applied to the secondary battery E2 even when, for example, a failure occurs in the transistor that controls the charging voltage or charging current, and therefore overcharge can be prevented from occurring.

### Second Embodiment

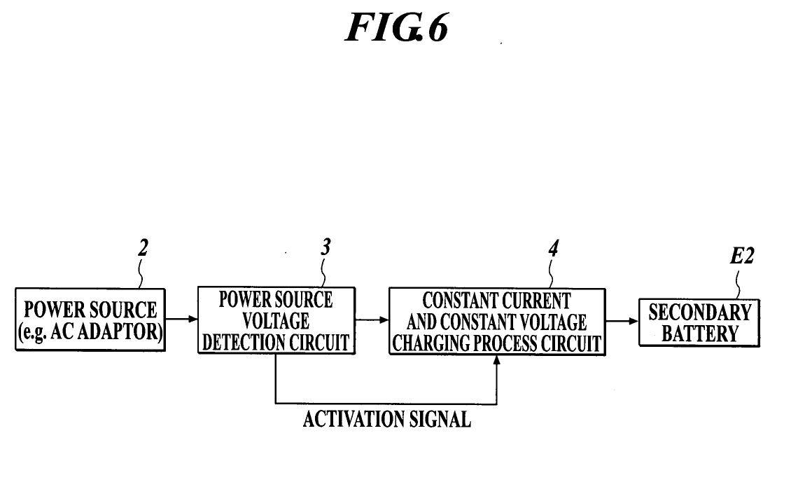

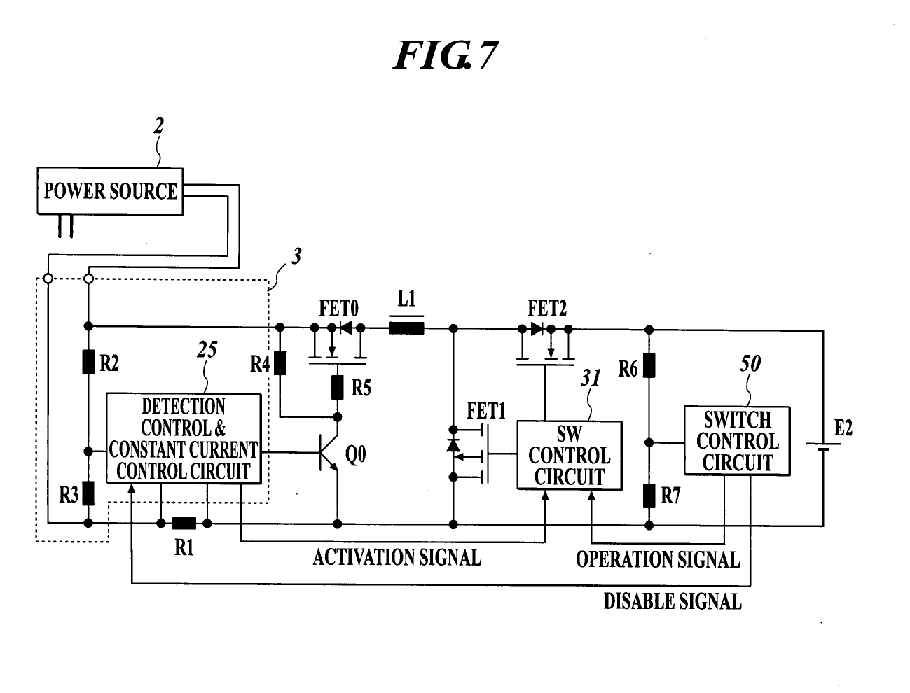

FIG. 6 is a block diagram showing the basic configuration of the charging system according to a second embodiment, and FIG. 7 shows an exemplary circuit configuration thereof.

The charging system according to the second embodiment is substantially the same as the charging system according to the first embodiment in that the power source voltage is set to a voltage that is lower than the full-charge voltage, and in that constant current charging without voltage step-up, constant current charging with voltage step-up and constant voltage charging at the full-charge voltage are performed according to the voltage of the battery during charging.

The charging system of the second embodiment has, in addition to the above described components, a power source voltage detection circuit 3 that detects the input voltage from the power source apparatus 2 and allows the operation of charge processing circuits (such as the constant current circuit and the voltage regulator) after verifying that the power source voltage is not higher than the full charge voltage. Furthermore, the charging system has a section for shutting off the input of the power source voltage if the power source voltage is not lower than the full-charge voltage.

As shown in FIG. 7, the power source voltage detection circuit 3 is composed of dividing resistances R2, R3 for outputting a detected voltage and a detection control and constant current control circuit 25 that performs detection controls such as turning off a transistor FET0 in the constant current circuit based on the detected voltage and outputting an activation signal to the SW control circuit 31 of the voltage regulator 30. The detection control and constant current control circuit 25 also serves as a control circuit for the constant current circuit that achieve constant current output by controlling the transistor FET0 during constant current charging.

The detection control and constant current control circuit 25 performs, in addition to the constant current control, a control for making the voltage regulator operable by supplying an activation signal to the SW control circuit 31 only when the power source voltage is not higher than the full-charge voltage, and a control for shutting off current supply to the second battery E2 by turning off the transistor FET0 that performs the constant current control when the power source voltage is not lower than the full-charge voltage.

In the second embodiment, a transistor FET2 that performs synchronous rectification is used as a rectifying device in the voltage regulator 30 to thereby reduce loss in the voltage regulator 30. Furthermore, a field effect transistor FET1 is used as a control transistor in the constant current circuit to thereby increase the withstand voltage and reduce loss. Thus, current input can be shut off even when a high voltage is applied as the power source voltage.

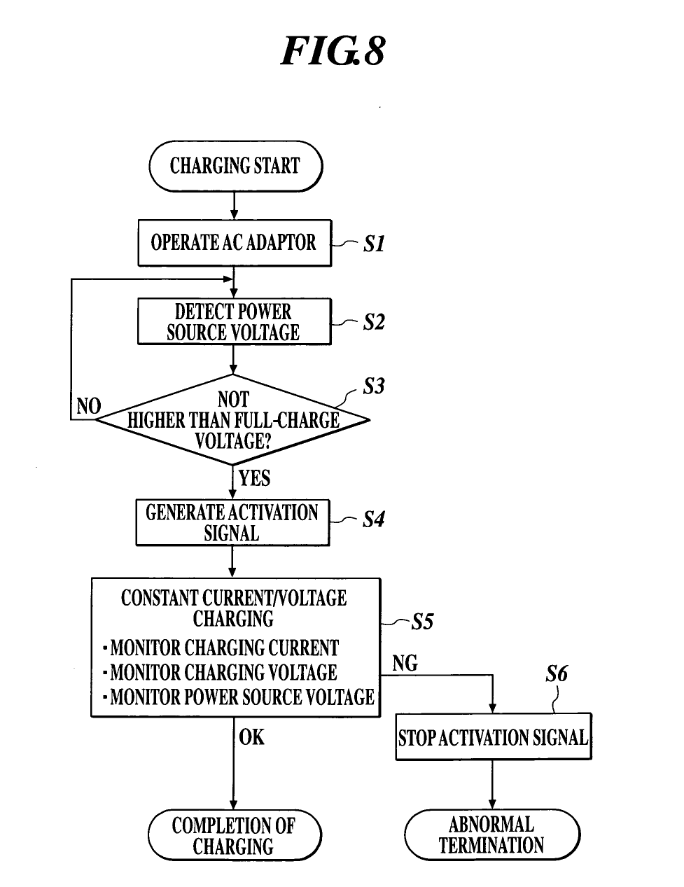

FIG. 8 is a flow chart of an exemplary operation procedure of this charging system.

In the charging system of this embodiment, when the power source voltage is supplied upon connection of a power source apparatus (step S1), the power source voltage detection circuit 3 detects the voltage of the power source (step S2), and a determination is made as to whether or not the voltage of the power source is lower than or equal to the full-charge voltage (step S3). If the voltage of the power source is higher than the full-charge voltage, the transistor FET0 in the constant current circuit is turned off by a control by the detection control and constant current control circuit 25, while the activation signal for the SW control circuit 31 is left to be negate.

Thus, when a power source voltage that is higher than the full-charge voltage is input, the power source voltage input is shut off, and the charging process is prevented from being performed.

On the other hand, if it is determined that the power source voltage is lower than the full-charge voltage, an activation signal is output from the detection control and constant current control circuit 25 to the SW control circuit 31, whereby the voltage regulator 30 is brought into an operable state (step S4). Then, the constant current circuit and the voltage regulator 30 perform the charging operation in cooperation according to the voltage of the battery based on monitoring of the battery voltage by the switch control circuit 50 (step S5).

When the power source voltage exceeds the full-charge voltage during the charging operation, the transistor FET0 is turned off by the detection control and constant current control circuit 25, the activation signal for the SW control circuit 31 is changed into negate (step S6), and the charging process is abnormally terminated.

As described above, according to the charging system of this embodiment, even when, for example, a power source apparatus having a high output voltage is erroneously connected, or when a high power source voltage is input due to a failure of the power source apparatus or other causes, such a voltage can be shut off and overcharge of the secondary battery E2 can be prevented from occurring.

### Third Embodiment

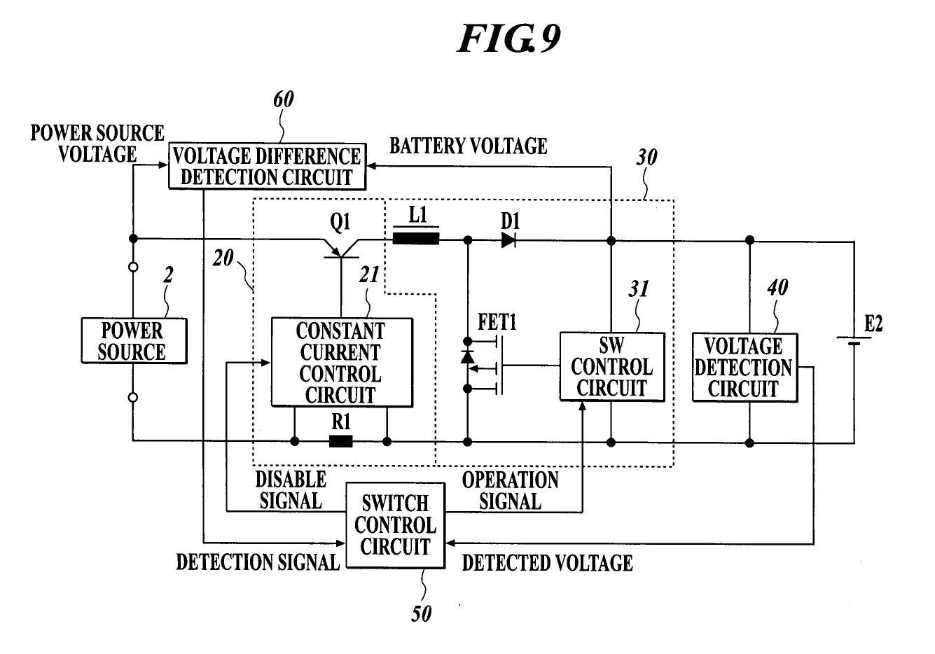

FIG. 9 shows the circuit configuration of a charging system according to a third embodiment.

The charging system of the third embodiment has substantially the same configuration as the charging system of the first embodiment, but only the section that generates operation timing of the voltage regulator 30 is modified.

In the charging system of this embodiment, the voltage difference between the power source voltage and the battery voltage is detected by a voltage difference detection circuit 60, and the time at which this voltage difference becomes equal to a reference voltage, that is, for example, the time at which “power source voltage E0”−“battery voltage E1”<“reference voltage of 0.05 to 0.2 V” is achieved, is detected as the time to start voltage step-up operation by switching operation of the transistor FET1. At this time, the voltage difference detection circuit 60 outputs a detection signal, and the switch control circuit 50 outputs an operation signal to the SW control circuit 31 based on this detection signal. Thus, a shift from the constant current charging without voltage step-up to the constant current charging with voltage step-up can be achieved at an appropriate timing.

The voltage detection circuit 40 that detects the battery voltage of the secondary battery E2 has not been eliminated, since the voltage detection circuit 40 is necessary to stop the control operation of the constant current circuit 20 when the battery voltage reaches the full-charge voltage.

As described above, optimum operation control can by achieved also by starting the voltage step-up operation of the voltage regulator 30 based on the voltage difference between the power source voltage and the battery voltage.

### Fourth Embodiment

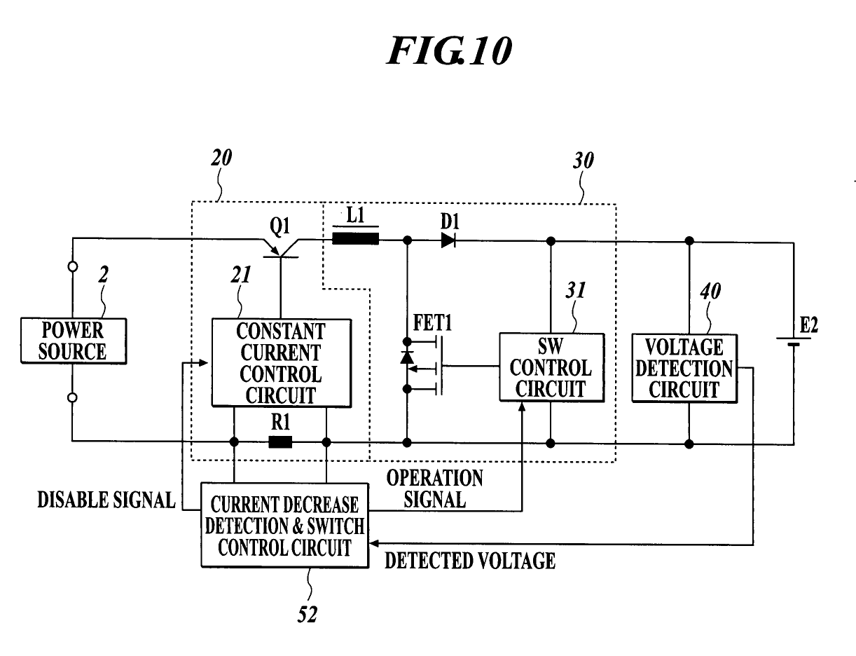

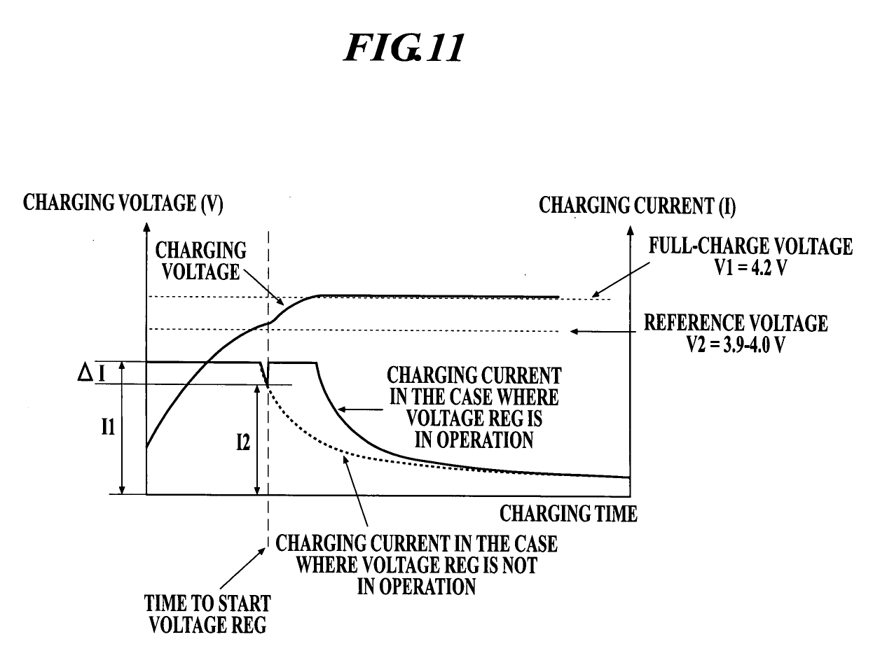

FIG. 10 shows the circuit configuration of a charging system according to a fourth embodiment, and FIG. 11 is a graphical illustration of charging characteristics of this charging system.

In the charging system according to the fourth embodiment, a section for generating operation timing of the voltage regulator 30 in the charging system according to the first embodiment has been modified. In the fourth embodiment, to determine timing for operating the voltage regulator 30, the current value is monitored during the constant current charging without voltage step-up, and the operation of the voltage regulator 30 is started when the current value has decreased by a reference amount.

To this end, in the charging system of this embodiment, a voltage for detecting the charging current is input to the switch control circuit 52, the current value of the constant current charging is monitored by the switch control circuit 52, and the switch control circuit 52 is configured to output an operation signal to the SW control circuit 31 of the voltage regulator 30 in response to a certain amount of decrease in the current value.

The operation of this charging system will be described with reference to FIG. 11.

In this charging system, as shown in FIG. 11, when the battery voltage is sufficiently lower than the power source voltage, constant current charging is performed only by operation of the constant current circuit 20 without operation of the voltage regulator 30. In this constant current charging, the battery voltage increases and comes close to the power source voltage as the charge amount becomes large, which makes it impossible to maintain the voltage for constant current charging and leads to a decrease in the charging current.

When the amount of decrease in the current reaches a certain value ΔI, the switch control circuit 52 outputs an operation signal to the SW control circuit 31 to activate the voltage regulator 30, whereby the operation is switched to the constant current charging with voltage step-up. Thereafter, when the battery voltage reaches the full-charge voltage, the constant current circuit 20 is disabled, and charging is continued by constant voltage charging by the operation of the voltage regulator 30 until the battery is fully charged, like in the case of the first embodiment.

As described above, optimum operation control of the voltage regulator 30 during constant current charging can also be achieved by operating the voltage regulator 30 based on the amount of decrease in the charging current, as is the case with the charging system according to this embodiment.

### Fifth Embodiment

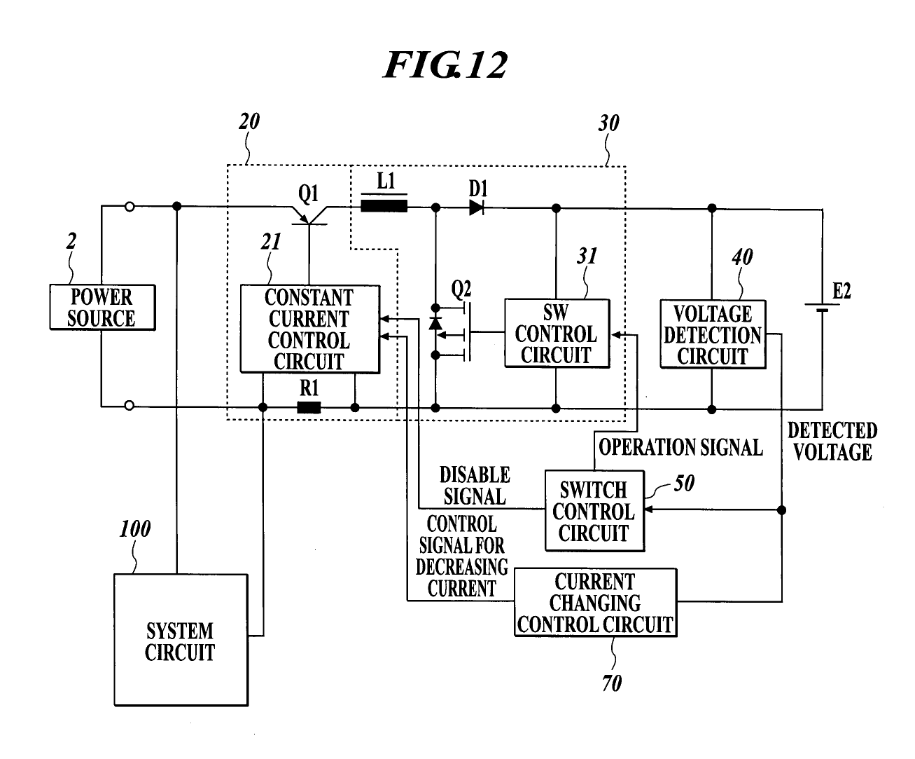

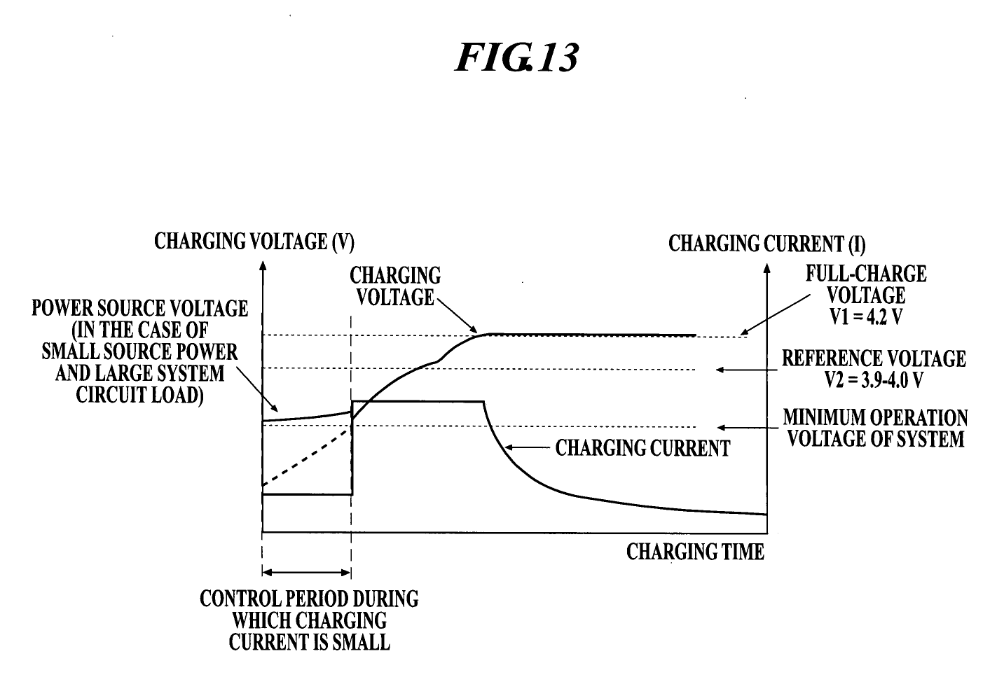

FIG. 12 shows the circuit configuration of a charging system according to a fifth embodiment, and FIG. 13 is a graphical illustration of charging characteristics of this charging system.

The charging system according to this embodiment is usefully applied to a system (such as, for example, a cellular phone) that operates with power supply from a secondary battery E2 in which charging is performed as the secondary battery E2 is set in the system, and the system circuit 100 is also supplied with power by the power source apparatus 2 for charging during charging of the secondary battery E2 so that the system circuit 100 can operate.

In such a system, in cases where the power source apparatus 2 does not have sufficient output power to spare, the power source voltage may decrease due to insufficiency of the output power if the charging current is large and the power supply to the system circuit 100 becomes large, and the operation of the system may be hindered.

In view of this, in the charging system of this embodiment, in order to eliminate such a disadvantage, if the voltage of the secondary battery E2 is lower than the minimum operation voltage of the system circuit 100, in other words if the system circuit 100 cannot be supplied with power by the battery voltage of the secondary battery E2, the charging current is made smaller to prevent insufficient power supply from the power source apparatus 2 to the system circuit 100 from occurring.

To achieve the above described function, this charging system is equipped, in addition to the components in the charging system of the first embodiment, with a current changing control circuit 70 that performs switching of the control operation of the constant current circuit 20 based on the battery voltage of the secondary battery E2.

As shown in FIG. 13, when the battery voltage of the secondary battery E2 is lower than the minimum operation voltage of the system circuit 100, the current changing control circuit 70 outputs a control signal for decreasing the charging current to the constant current control circuit 21. This causes the output current of the constant current circuit 20 to be set to a value that is a step lower (e.g. 0.1 C-0.3 C). When the battery voltage of the secondary battery E2 becomes higher than the minimum operation voltage of the system circuit 100 by a certain margin, the current changing control circuit 70 negates the control signal for decreasing the charging current. This causes the constant current circuit 20 to change its current value back into a prescribed value (e.g. 1 C).

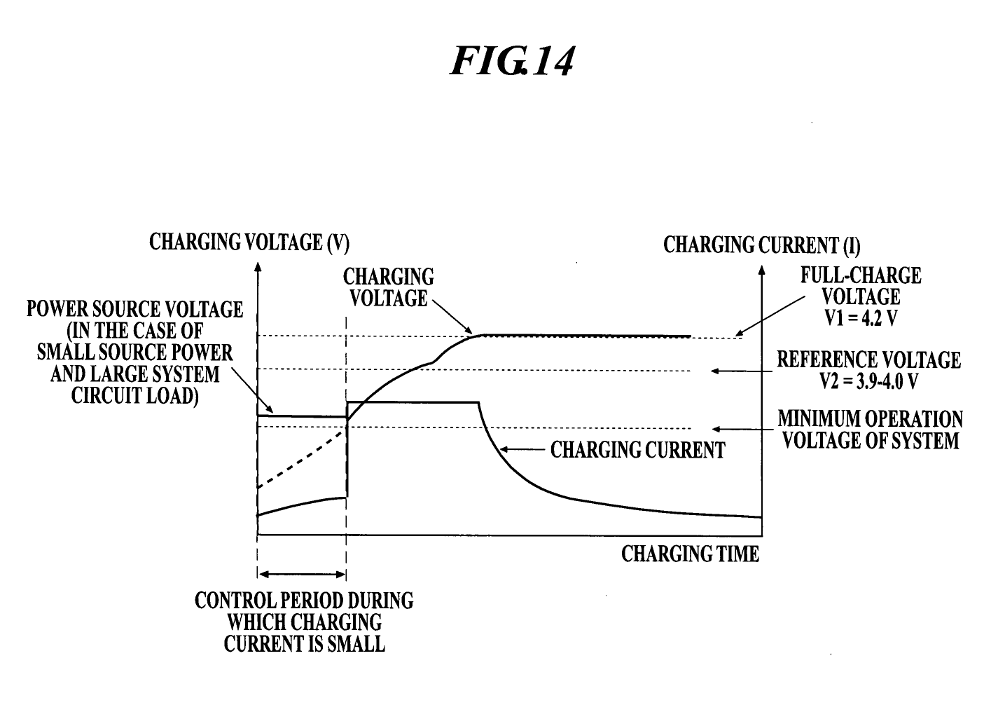

When the changing signal for decreasing the current is input, the constant current circuit 20 may perform a control in such a way as to change the amount of the output current in accordance with the battery voltage to thereby making the power source voltage supplied from the power source apparatus 2 to the system circuit 100 constant as shown in FIG. 14, instead of controlling in such a way as to make the output current constant at a small current.

As described above, according to the charging system of this embodiment, it is possible to eliminate the disadvantage that when the power source voltage is used both to charge the secondary battery E2 and to drive a system, driving of the system becomes impossible as the power load of charging increases.

### Sixth Embodiment

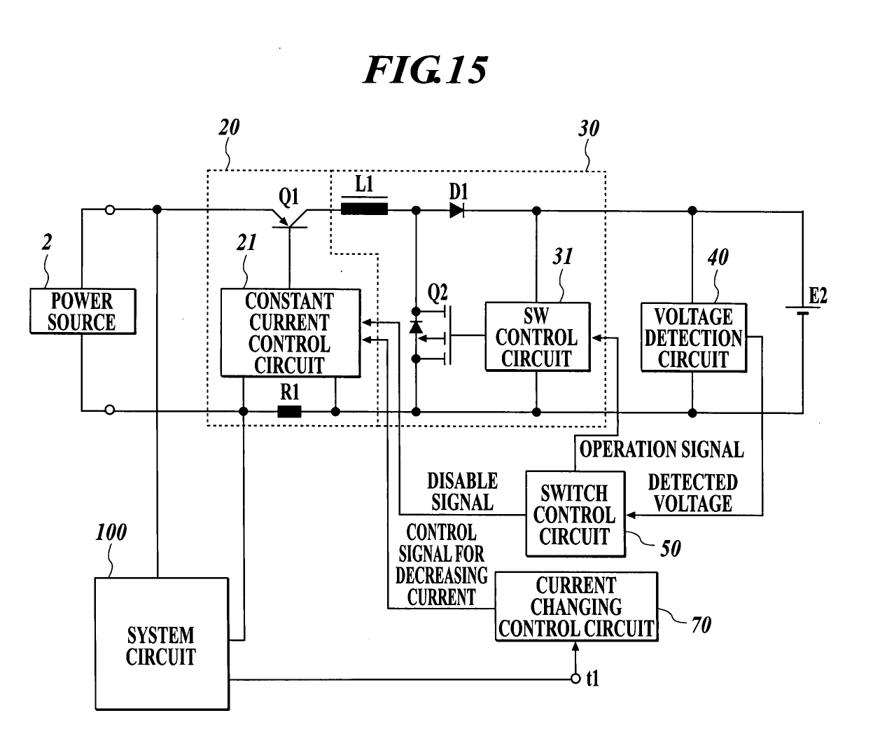

FIG. 15 shows the circuit configuration of a charging system according to a sixth embodiment.

The charging system of this embodiment is designed in such a way that when both charging of a secondary battery E2 and driving of a system are performed using a power source voltage, insufficient power supply to a system circuit 100 due to uneven power load biased toward charging of the secondary battery E2 is prevented from occurring, like in the case of the fifth embodiment.

To this end, this charging system is provided with an input terminal t1 to which a signal indicative of operation mode of the system is input from the system circuit 100. When the signal on the input terminal t1 indicates that the system is in normal operation mode or high load operation mode, the charging system is controlled in such a way that the output current of the constant current circuit 20 is decreased so as to increase power that can be supplied from the power source apparatus 2 to the system circuit 100.

In this charging system, if the load of the system becomes high while the power source voltage is used both to charge the secondary battery E2 and to drive a system, adequate power for charging can be provided by decreasing the charging current, and therefore inconvenient system shutdown due to increased power load in charging can be prevented from occurring.

### Seventh Embodiment

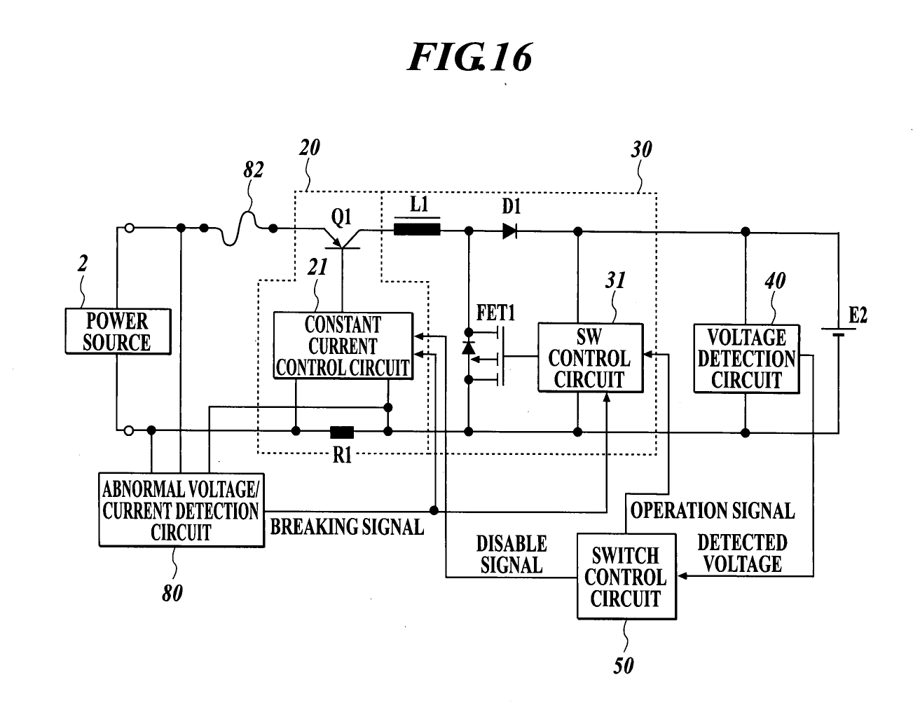

FIG. 16 shows the circuit configuration of a charging system according to a seventh embodiment.

The charging system of this embodiment has, in addition to the configuration of the charging system according to the first embodiment, a function of shutting down the input from the power source terminal by blowing a fuse 82 when excessively high voltage or excessively large current is input to the power source terminal.

This charging system is provided with a fuse 82 connected on the power source terminal side of the current path that connects the power source terminal and the secondary battery E2 and an abnormality detection circuit 80 that monitors the input voltage or input current on the power source terminal and outputs a breaking signal for breaking or blowing the fuse 82 when an excessive input occurs.

The fuse 82 may be an ordinary fuse that will be blown by a current larger than a rated current or a resistive fuse that has a resistance component and is blown by a power higher than a specific power.

When abnormality is detected, the abnormality detection circuit 80 outputs a breaking signal to the SW control circuit 31 of the voltage regulator 30 and the control circuit 21 of the constant current circuit 20. These control circuits 21, 31 turn on the transistor Q1 and the transistor FET1 in response to the breaking signal to short-circuit the power source terminals by a current path through the fuse 82, which is separated from the secondary battery E2, thereby blowing the fuse 82.

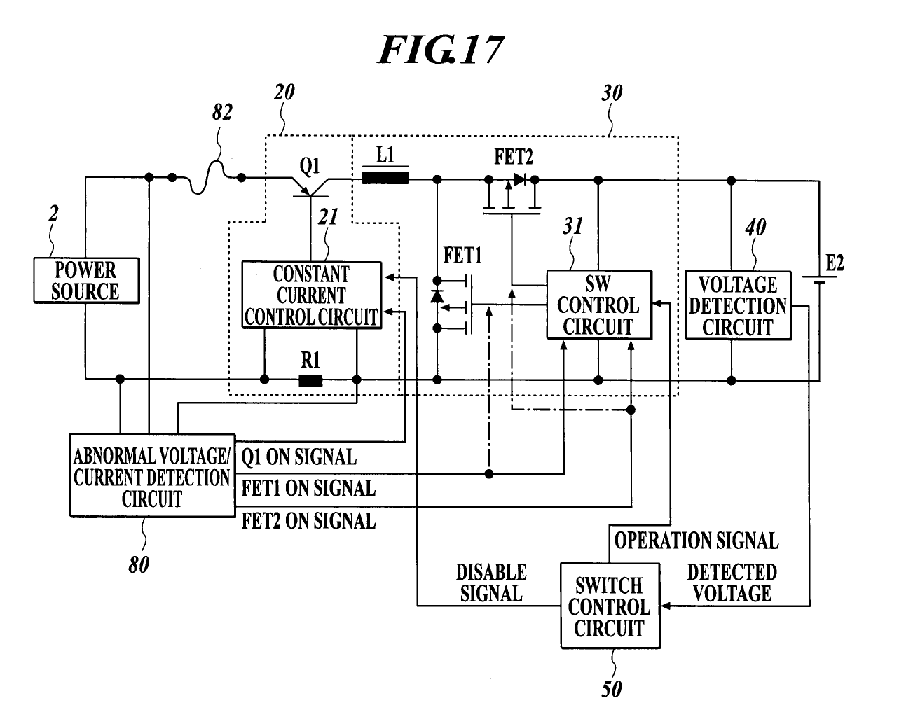

FIG. 17 shows a modification of the section for blowing the fuse in the circuit configuration of the charging system.

As shown in FIG. 17, in the case where a transistor FET2 for synchronous rectification is used as a rectifying device of the voltage regulator 30, it is considered that when the transistor FET1 is turned on to blow the fuse 82, discharge from the secondary battery E2 through this transistor FET1 will occur. Therefore, in the case where the voltage regulator 30 of the synchronous rectification type is used, it is preferred that when the breaking signal is input, the transistor FET2 be controlled to be turned off to shut off discharge of the secondary battery E2.

As shown by the alternate long and short dash lines in FIG. 17, when the fuse 82 is to be blown, instead of controlling the on/off of the transistors FET1, FET2 through the SW control circuit 31 of the voltage regulator 30, the abnormality detection circuit 80 may directly drive the transistors FET1, FET2 to achieve the same operation.

Alternatively, a switch device and a current path dedicated to blowing the fuse may be provided, and the fuse 82 may be blown by controlling the on/off of the switch device. If a discharge path of the secondary battery E2 is formed upon blowing the fuse, it is preferred that a switch device for blocking the discharge path be provided to perform a control for blocking the discharge path.

As described above, in the charging system of this embodiment, even if high voltage or large current is input to the power source terminals accidentally, blowing of the fuse 82 will prevent the secondary battery E2 from being affected by the input. Thus, the charging system can have improved safety.

### Eighth Embodiment

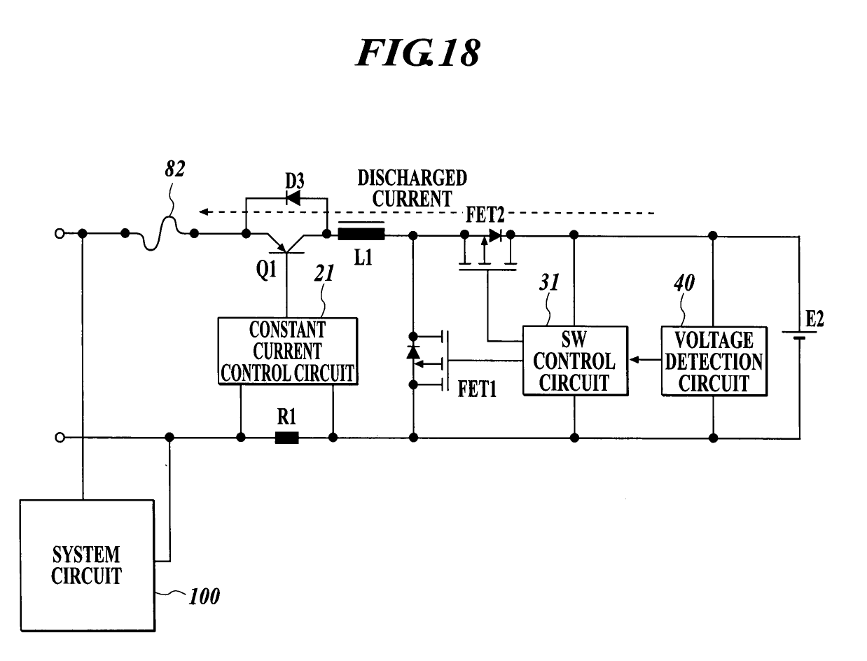

FIG. 18 shows the circuit configuration of a charging system according to an eighth embodiment.

The charging system of this embodiment is designed to be capable of supplying power from the secondary battery E2 to a system circuit 100 through a charging circuit when the power source terminals are open.

To this end, this charging system is equipped with a voltage regulator 30 of a synchronous rectification type in which a transistor FET2 is used as a rectifying device of the voltage regulator 30.

Furthermore, a rectifying device D3 having a cathode arranged on the input side is connected in parallel with a current control device (transistor Q1) of the constant current circuit 20.

With this configuration, by turning on the transistor FET2 for synchronous rectification in the voltage regulator 30, current can be supplied from the secondary battery E2 to a system circuit 100 through the transistor FET2, a reactor L1 and the rectifying device D3. Furthermore, the voltage output to the system circuit 100 can be adjusted by causing the voltage regulator 30 to operate as a voltage step-down switching regulator with the reversed output direction.

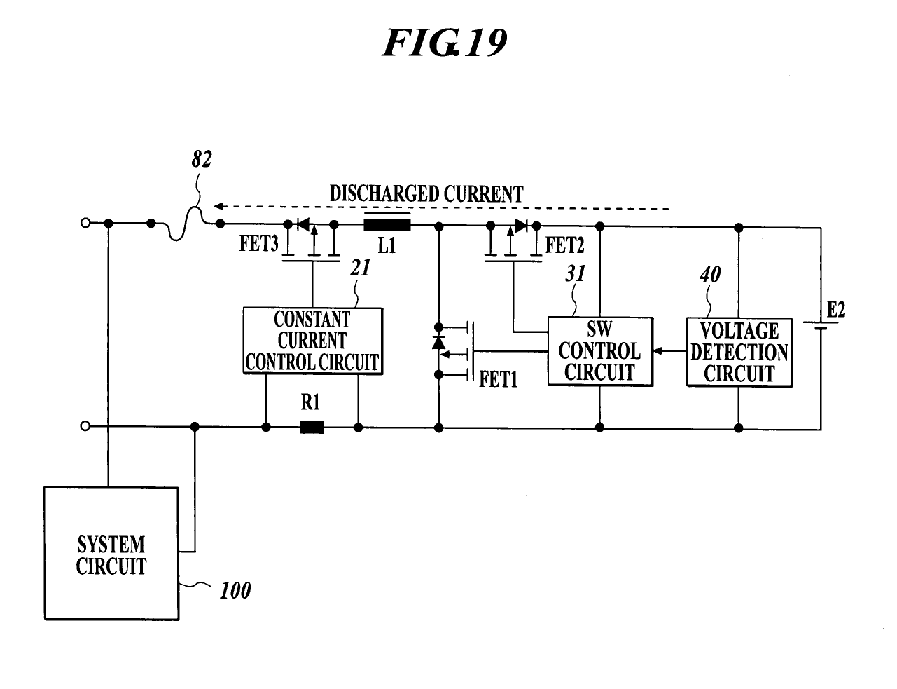

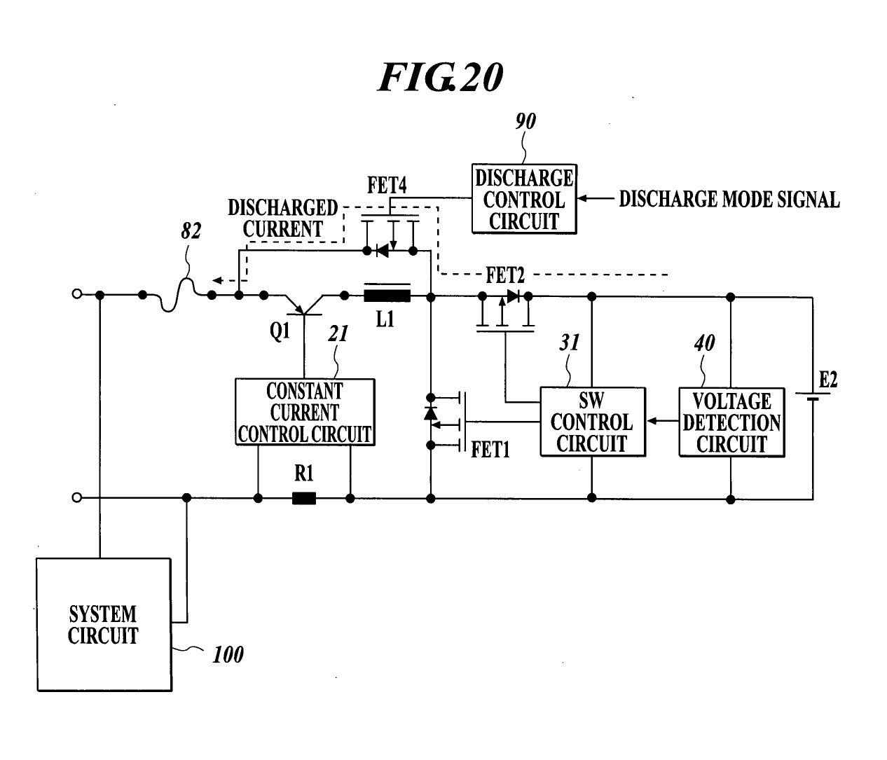

FIGS. 19 and 20 show modifications of the charging system that is designed to be capable of supplying power from the secondary battery E2 to the system circuit through the charging circuit.

The section for supplying current from the secondary battery E2 to the system circuit 100 while bypassing the constant current circuit 20 may be configured in various ways. For example, as shown in FIG. 19, the operation same as the operation of the charging system shown in FIG. 18 is achieved by using a field effect transistor FET3 with a body diode having a cathode arranged on the input side as a transistor for current control in the constant current circuit 20. Specifically, current can be supplied to the system circuit through the body diode of the transistor FET3.

With this configuration, by turning on the transistor FET2 for synchronous rectification in the voltage regulator 30, current can be supplied from the secondary battery E2 to the system circuit 100 through the transistor FET2, the reactor L1 and the body diode of the transistor FET3.

As shown in FIG. 20, a field effect transistor FET4 may be connected in parallel with a transistor Q1 for current control or a reactor L1 in the voltage regulator 30 so that the on/off of the transistor FET4 can be controlled by a discharge control circuit 90. When in discharge mode, the discharge control circuit 90 may turn the transistor FET4 on, whereby current can be supplied from the secondary battery E2 to the system circuit 100.

As described above, in the charging system of this embodiment, discharge from the secondary battery E2 to the system circuit 100 is made possible by connecting the system circuit 100 in parallel to the power source terminals.

Although the present invention has been described based on the embodiments, the present invention is not limited to the above-described embodiments. For example, although the second battery has been exemplified by a lithium ion battery, other secondary batteries having similar charging characteristics may also be used. The circuit configurations and operations specifically described with the embodiments may be suitably changed without departing from the essence of the invention.

### INDUSTRIAL APPLICABILITY

The present invention can be applied to a secondary battery charging circuit that charges a secondary battery such as, for example, a lithium ion battery.

1-11. (canceled)

12. A second battery charging circuit that charges a secondary battery by an input power source voltage, comprising:
a power source voltage detection circuit that detects the power source voltage,
wherein the power source voltage detection circuit activates charging operation when it detects that the power source voltage is lower than the full-charge voltage.

13. A secondary battery charging circuit as recited in claim 12, further comprising a first switch device provided in a current path that connects the power source voltage and the secondary battery, the first switch opening and closing the current path,
wherein the power source voltage detection circuit turns the first switch device off when it detects that the power source voltage is higher than the full-charge voltage.

14. A secondary battery charging circuit as recited in claim 12, further comprising:
a current circuit that controls current supplied from the power source voltage to the secondary battery, and
a voltage step-up circuit that steps-up the power source voltage,
wherein when the voltage of the secondary battery is lower than the power source voltage, the current circuit operates to perform constant current charging without voltage step-up, and
wherein when the voltage of the secondary battery is higher than the power source voltage and lower than the full-charge voltage, the voltage step-up circuit operates to perform constant current charging with voltage step-up.

15. A secondary battery charging circuit as recited in claim 14, further comprising:
a voltage difference detection circuit that detects a voltage difference between the power source voltage and the voltage of the secondary battery,
wherein when the voltage difference detection circuit detects that the voltage difference becomes equal to or lower than a reference value during a period of the constant current charging without voltage step-up, the voltage step-up circuit is activated based thereon to make the shift to the constant current charging with voltage step-up.

16. A secondary battery charging circuit as recited in claim 14, further comprising a current decrease detection circuit that detects a decrease in charging current,
wherein when the current decrease detection circuit detects that the charging current has decreased by a specific amount during a period of the constant current charging without voltage step-up, the voltage step-up circuit is activated based thereon to make the shift to the constant current charging with voltage step-up.

17. A secondary battery charging circuit as recited in claim 14, further comprising a battery voltage detection circuit that detects a voltage of the secondary battery,
wherein the current circuit changes the magnitude of the charging current based on the voltage value of the secondary battery.

18. A secondary battery charging circuit as recited in claim 17, wherein when the voltage of the secondary battery is higher than a minimum operation voltage of a system that operates with voltage supply from the secondary battery, the current circuit adjusts the charging current to a first current value, and when the voltage of the secondary battery is lower than the minimum operation voltage, the current circuit adjusts the charging current to a current value that is smaller than the first current value.

19. A secondary battery charging circuit as recited in claim 14, further comprising a control terminal to which a signal indicative of an operation mode of a system that operates with voltage supply from the secondary battery is input from the system,
wherein the current circuit changes the magnitude of the charging current based on the signal on the control terminal.

20. A secondary battery charging circuit as recited in claim 12, further comprising:
a fuse provided in a current path that connects the power source voltage and the secondary battery;
a voltage and current detection circuit that detects the power source voltage and an input current; and
a second switch device directly connected with the fuse,
wherein when the power source voltage or input current exceeds a limit value, the second switch device is turned on to blow the fuse.

21. A secondary battery charging circuit as recited in claim 20, wherein the circuit is provided with a rectifying device or a third switch device that can block current from the secondary battery so as to prevent current from flowing from the secondary battery to the second switch device when the second switch device is turned on.
